(19) United States
(12) Patent Application Publication
(10) Pub. No.: US 2011/0292685 A1
(43) Pub. Date: Dec. 1, 2011

(54) INTEGRATED LIGHT GUIDE PLATE AND BACKLIGHT UNIT INCLUDING THE SAME

(75) Inventors: Dong Hyun PARK, ChungCheongNam-Do (KR); Jin Sung LIM, ChungCheongNam-Do (KR); Dae Chul PARK, ChungCheongNam-Do (KR); Seok Won KIM, ChungCheongNam-Do (KR)

(73) Assignee: SAMSUNG CORNING PRECISION MATERIALS CO., LTD.

(21) Appl. No.: 13/114,855

(22) Filed: May 24, 2011

(30) Foreign Application Priority Data
May 28, 2010 (KR) 10-2010-0050008

(51) Int. Cl. F21V 8/00

(52) U.S. Cl. 362/624

(57) ABSTRACT

An integrated light guide plate and a backlight unit including the same. The integrated light guide plate includes a light guide plate, which forms planar light by guiding light, and a reflecting mirror, which is integrally formed on an underside of the light guide plate. The reflecting mirror reflects light that has downwardly passed through the light guide plate so that the light is introduced again into the light guide plate. The reflecting mirror includes a buffer layer, which is formed on the underside of the light guide plate, and a reflecting layer, which is formed on an underside of the buffer layer. The reflecting layer reflects light that has downwardly passed through the light guide plate so that the light is introduced again into the light guide plate. A protective layer is formed on an underside of the reflecting layer, and protects the reflecting layer.

### CROSS REFERENCE TO RELATED APPLICATION

The present application claims priority from Korean Patent Application Number 10-2010-0050008 filed on May 28, 2010, the entire contents of which application are incorporated herein for all purposes by this reference.

### BACKGROUND OF THE INVENTION

1. Field of the Invention

The present invention relates to an integrated light guide plate used in a Liquid Crystal Display (LCD) and a backlight unit including the same.

2. Description of Related Art

In general, an LCD includes two glass plates and liquid crystal disposed therebetween, and displays an image by producing bright and dark elements through changes in the arrangement of liquid crystal molecules in response to electrical current applied thereto. The LCD needs a backlight unit providing planar light, since the LC cannot generate light by itself unlike a Plasma Display Panel (PDP), a Field Emission Display (FED), or an Organic Electronic Luminescent Display (OELD).

FIG. 1 is a perspective view schematically showing the overall structure of a backlight unit in an LCD of the related art.

Referring to FIG. 1, a backlight unit includes a light source 11, a reflector sheet 12, a light guide plate 13, a diffuser sheet 14, first and second prism sheets 15 and 16, a luminance enhancement film 17, and a protective film 18. Here, the light source 11 may be a Light Emitting Diode (LED) made of one selected from among, but not limited to, GaAlAs, AlGaIn, AlGaInP, AlGaInPAs, and GaN, or a Cold Cathode Fluorescent Lamp (CCFL), a type of discharge lamp. The light guide plate converts line light or point light emitted from the light source 11 into uniform planar light. The diffuser sheet 14 diffuses light that is emitted from the light guide plate 13. The reflector sheet 12 is disposed below the light guide plate 13, and reflects light that is emitted from the underside of the light guide plate 13 so that the light is introduced again into the light guide plate 13. The first and second prism sheets 15 and 16 are arranged to be perpendicular to each other, and condense light that has passed through the diffuser sheet 14. The luminance enhancement film 17 serves to increase the luminance of light that is condensed by the first and second prism sheets 15 and 16.

However, the backlight unit of the related art has a problem in that blurring, attributable to internal heat generated by the light source 11 and a moist external environment, occurs on the reflector sheet 12 since an air gap exists between the light guide plate 13 and the reflector sheet 12. Meanwhile, because the current trend in the display market is toward slimness, the backlight unit is required to be thinner compared to existing products.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an integrated light guide plate, which is slim, and a backlight unit including the integrated light guide plate.

Also provided are an integrated light guide plate, which has excellent moisture resistance, and a backlight unit including the integrated light guide plate.

In an aspect of the present invention, the integrated light guide plate includes a light guide plate. The light guide plate forms planar light by guiding light. A reflecting mirror is integrally formed on an underside of the light guide plate, and reflects light that has downwardly passed through the light guide plate so that the light is introduced again into the light guide plate. The reflecting mirror includes a buffer layer, which is formed on the underside of the light guide plate, and a reflecting layer, which is formed on the buffer layer. The reflecting layer reflects light that has downwardly passed through the light guide plate so that the light is introduced again into the light guide plate. A protective layer is formed on the underside of the reflecting layer, and protects the reflecting layer. The buffer layer enhances the bonding force between the reflecting layer and the light guide plate.

According to embodiments of the present invention, the integrated light guide plate and the backlight unit including the same have an advantage in that the structure of the backlight unit can be designed to be slim since the reflecting mirror is integrally formed to the light guide plate as a coating layer.

In addition, the integrated light guide plate and the backlight unit including the same have an advantage in that they have excellent moisture resistance in humid environments, since no air gap is interposed between the reflecting mirror and the light guide plate and the reflecting mirror has the protective layer to protect the reflecting layer.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a perspective view schematically showing the overall structure of a backlight unit of an LCD of the related art;

FIG. 2 is a cross-sectional view illustrating a backlight unit according to an exemplary embodiment of the present invention;

FIGS. 3A and 3B are cross-sectional views illustrating the integrated light guide plate shown in FIG. 2; and

FIGS. 4A to 4C are graphs showing the variation in light reflectivity depending on the thickness of a reflecting layer of an integrated light guide plate.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

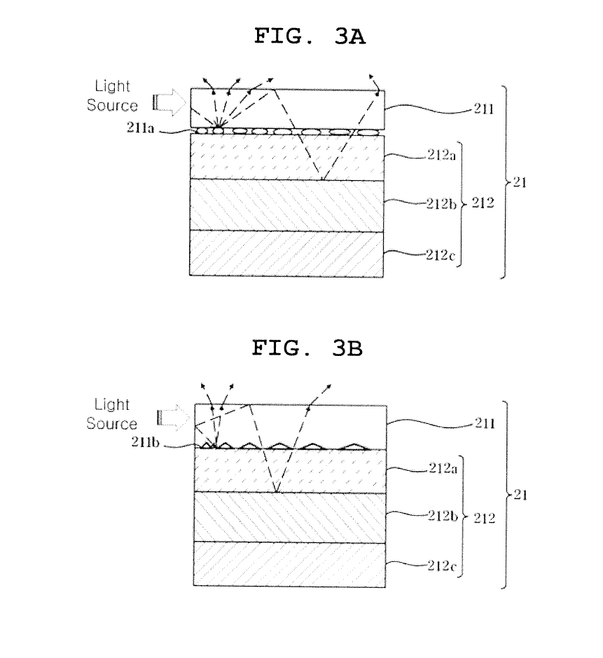

FIG. 2 is a cross-sectional view illustrating a backlight unit according to an exemplary embodiment of the present invention, and FIGS. 3A and 3B are cross-sectional views illustrating the integrated light guide plate shown in FIG. 2.

As shown in FIG. 2, the backlight unit of this embodiment generally includes an integrated light guide plate 21, a diffuser sheet 22, a prism sheet 23, and a luminance enhancement sheet 24.

The integrated light guide plate 21 serves to convert line light or point light that is emitted from a light source into planar light, and emits planar light toward the diffuser sheet 22. As shown in FIGS. 3A and 3B, according to characteristic aspects of the present invention, the integrated light guide plate 21 includes a light guide plate 211 and a reflecting mirror 212. The reflecting mirror 212 is integrally formed on the underside of the light guide plate 211 as a coating layer.

The light guide plate 211 forms uniform planar light by guiding line light or point light that is emitted from the light source. The light guide plate 211 can be made of one selected from among, but not limited to, acryl, Urethane Acrylate (UA), Epoxy Acrylate (EA), Polymethyl Methacrylate (PMMA), and Polycarbonate (PC).

As shown in FIG. 3A, a pattern of dots 211a can be formed on the light guide plate 211 in order to reflect light that is traveling through the light guide plate 211. In an example, the number of dots 211a can be configured such that their diameters increase as distance form the light source increases, so that light that is introduced from the light source can be scattered and irregularly reflected to maintain uniform luminance. In another example, as shown in FIG. 3B, a pattern of protrusion-depression structures 211b can be formed in order to reflect light traveling through the light guide plate 211. The protrusion-depression structures 211b can be formed by dry or wet etching, with the cross section thereof being, for example, a triangle, a quadrangle, a pentagon, or an ellipse. The protrusion-depression structures 211b can be configured such that their sizes increase as distance form the light source increases, so that light that is introduced from the light source can be scattered and irregularly reflected to maintain uniform luminance.

In an example, the light guide plate 211 can be fabricated by applying an Ultraviolet (UV) curable resin on an acrylate resin plate having a predetermined thickness, pressing a master having a protrusion-depression pattern onto the plate from above, and radiating UV rays on the plate under predetermined conditions such that protrusion-depression structures are replicated on the acrylate resin plate. In another example, a light guide plate can be fabricated by hot-pressing a master roll onto an acrylate resin plate having a predetermined thickness. The master roll may be obtained by attaching a master having a depression-protrusion pattern onto the outer surface of a roll or by forming a master having a depression-protrusion pattern directly on the outer surface of a roll. The protrusion-depression pattern is replicated on the surface of the resin plate. In a further example, the light guide plate 211 can be fabricated by printing a dot pattern of a light-diffusing material on the underside of a plate made of, for example, PMMA or PC.

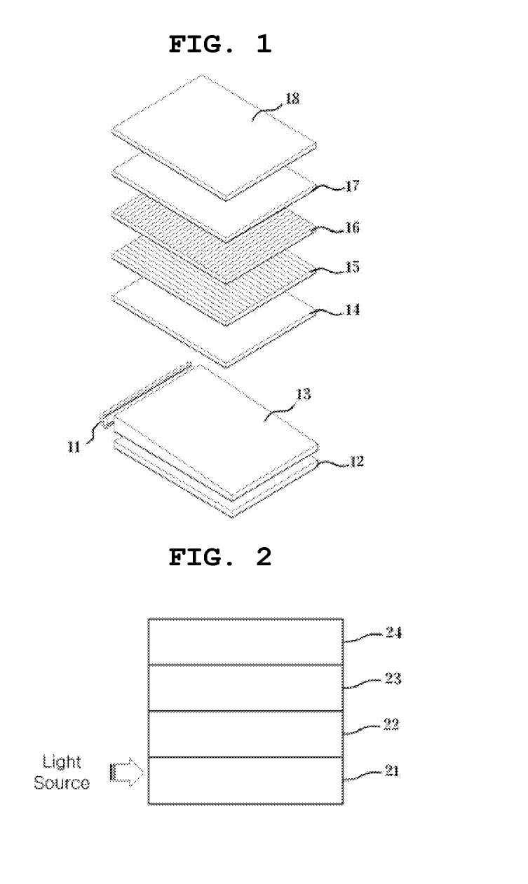

The reflecting mirror 212 is a coating layer that is integrally formed on the underside of the light guide plate 211. The reflecting mirror 212 serves to reflect light that has downwardly passed through the light guide plate 211 so that the light is introduced again into the light guide plate 211. A reflecting sheet of the related art (reference numeral 12 in FIG. 1) is in the form of a separate sheet, which includes a resin composition containing a reflecting material, while the reflecting mirror 212 of this embodiment can be formed in the form of a thin film via physical vapor deposition, such as sputtering, electron beam evaporation, thermal evaporation, molecular beam epitaxy, or hydride vapor phase epitaxy. In addition, the reflecting mirror 212 of this embodiment can be formed in the form of a thin film via chemical vapor deposition, such as Metalorganic Chemical Vapor Deposition (MOCVD), Plasma Enhanced Chemical Vapor Deposition (PECVD), Atmospheric Pressure Chemical Vapor Deposition (APCVD), Low Pressure Chemical Vapor Deposition (LPCVD), and Ultra High Vacuum Chemical Vapor Deposition (UHV CVD).

As shown in FIGS. 3A and 3B, the reflecting mirror 212 includes a buffer layer 212a, a reflecting layer 212b, and a protective layer 212. The buffer layer 212a is formed under the light guide plate 211, and serves to enhance the bonding force between the reflecting layer 212b and the light guide plate 211. Without the buffer layer 212a, the reflecting layer may be easily peeled off from the light guide plate, thereby durability decreasing significantly. The buffer layer 212a can be made of titanium (Ti) or a Ti alloy.

The reflecting layer 212b serves to reflect light that has downwardly passed through the light guide plate 211 so that the light is introduced again into the light guide plate 211. The reflecting layer 212b may be made of a metal, in an example, selected from among, but not limited to, silver (Ag), aluminum (Al), copper (Cu), and gold (Au). It is preferred that the thickness of the reflecting layer 212b range from 70 nm to 200 μm. If the thickness of the reflecting layer 212b is less than 70 nm, the reflectivity is bad. If the thickness is more than 200 μm, stress is caused in the reflecting layer 212b, and thereby the crack in the reflecting layer 212b occurs. In addition, the deposition time increases and thereby the productivity deteriorates and the cost increases.

The protective layer 212c is formed under the reflecting layer 212b, and is used as an oxidation resistant layer, which prevents the reflecting layer 212b from being oxidized by an external environment such as a hot and humid environment. Without the protective layer 212c, the metal reflecting layer is corroded, thereby significantly losing its reflective function. In an example, the protective layer 212c is made of one selected from among, but not limited to, titanium dioxide (TiO₂), zinc oxide (ZnO), tin dioxide (SnO₂), niobium oxide (Nb₂O₅), and aluminum oxide (Al₂O₃).

As shown in FIGS. 3A and 3B, the integrated light guide plate of this embodiment has slim structure without any air gap between the light guide plate 211 and the reflecting mirror 212, and has excellent moisture resistance even in a humid environment since the reflecting mirror 212 includes the protective layer 212c, which protects the reflecting layer 212b.

Returning to FIG. 2, the diffuser sheet 22 diffuses light that exits the integrated light guide plate 21. In an example, the diffuser sheet 22 includes a base film, a diffusing layer formed on the upper surface of the base film, and an anti-blocking layer formed on the underside of the base film. The base film is made of a polymeric material selected from among, but not limited to, Polyethylene Terephthalate (PET), Polycarbonate (PC), and Polyvinyl Chloride (PVC). Light-diffusing beads are distributed in the diffusing layer and the anti-blocking layer. Here, the amount of incident light and a diffusibility vary depending on the size and density of the light-diffusing beads distributed in the diffusing layer. The beads distributed in the anti-blocking layer are small and uniform, and thus the function of diffusing light is small. The anti-blocking layer protects the integrated light guide plate 21, which is disposed under the diffuser sheet 22, and prevents impurities from becoming adhered due to static electricity.

The prism sheet 23 condenses light that has upwardly passed through the diffuser sheet 22. The prism sheet 23 includes a base film and protrusion-depression structures formed on the upper surface of the base film. The base film is made of one selected from among, but not limited to, Polyethylene Terephthalate (PET), Polycarbonate (PC), and Polyvinyl Chloride (PVC).

The luminance enhancement sheet 24 serves to enhance the luminance of light that is condensed by the prism sheet 23. In an example, the luminance enhancement sheet 24 can be a Dual Brightness Enhancement Film (DBEF) or a Brightness Enhancement Film (BEF), which are available from 3M.

Below, a description is made of the results that are obtained by measuring the luminance of light of a backlight unit, which includes the integrated light guide plate, the diffuser sheet, the prism sheet, and the luminance enhancement sheet according to the present invention, while variously modifying the structure of the integrated light guide plate.

TABLE 1

| | Structure of integrated light guide | Luminance |
|---|---|---|
| | plate | (Lux) |
| Comparative | PMMA LGP + Air gap + Reflector sheet | 2800 |
| Example | | |
| Example 1 | Dot pattern printed PMMA LGP + | 2600 |
| | Reflecting mirror | |
| Example 2 | PMMA LGP having protrusion-depression | 2900 |
| | structures + Reflecting mirror | |

Note)
LGP: Light Guide Plate

Each of Examples 1 and 2 was fabricated such that an integrated light guide plate of a backlight unit includes a PMMA light guide plate and a reflecting mirror, which is integrally formed on the underside of the light guide plate. A dot pattern was printed on the light guide plate of Example 1, whereas protrusion-depression structures were formed on the light guide plate of Example 2.

As presented in Table 1 above, the luminance of light of the backlight units of Examples 1 and 2 are 2600 lux and 2900 lux, respectively, which are similar to that of a backlight unit of the related art.

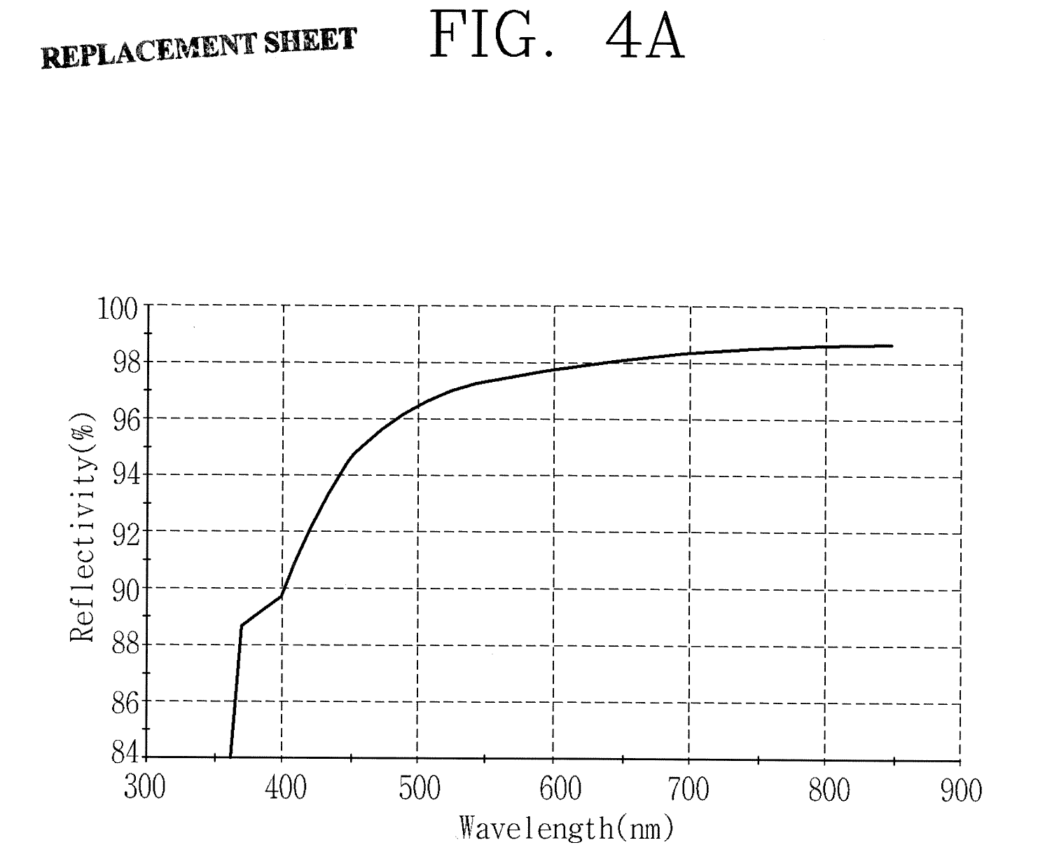

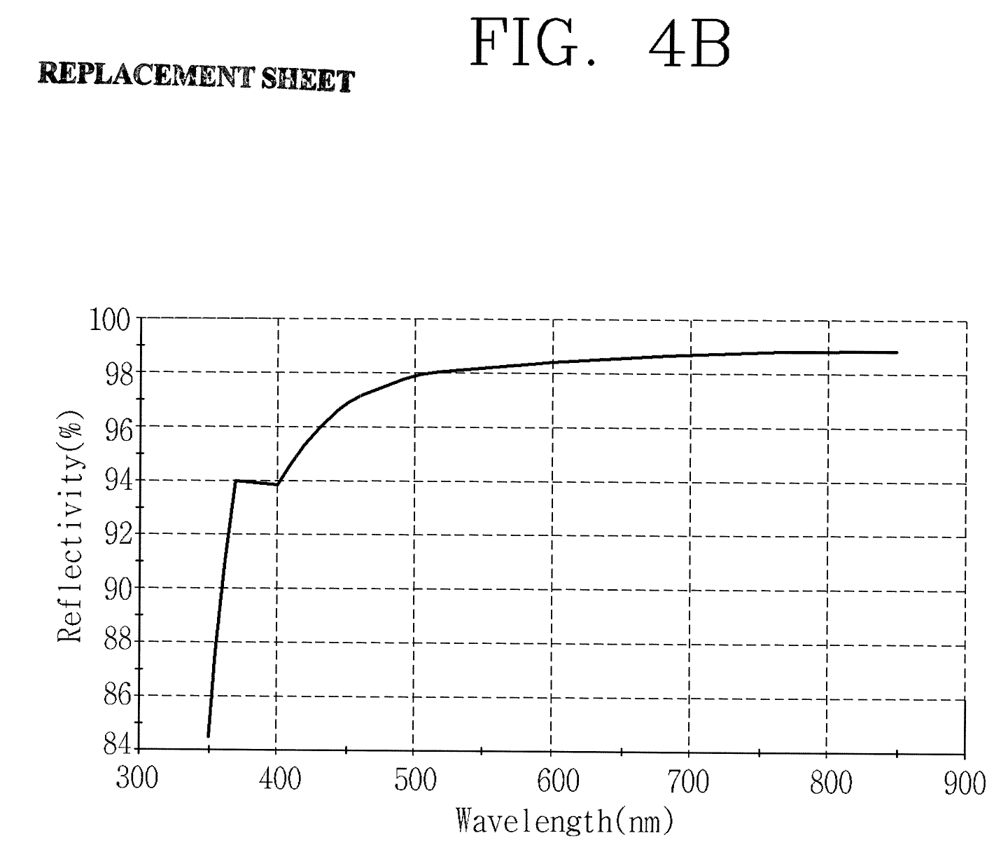

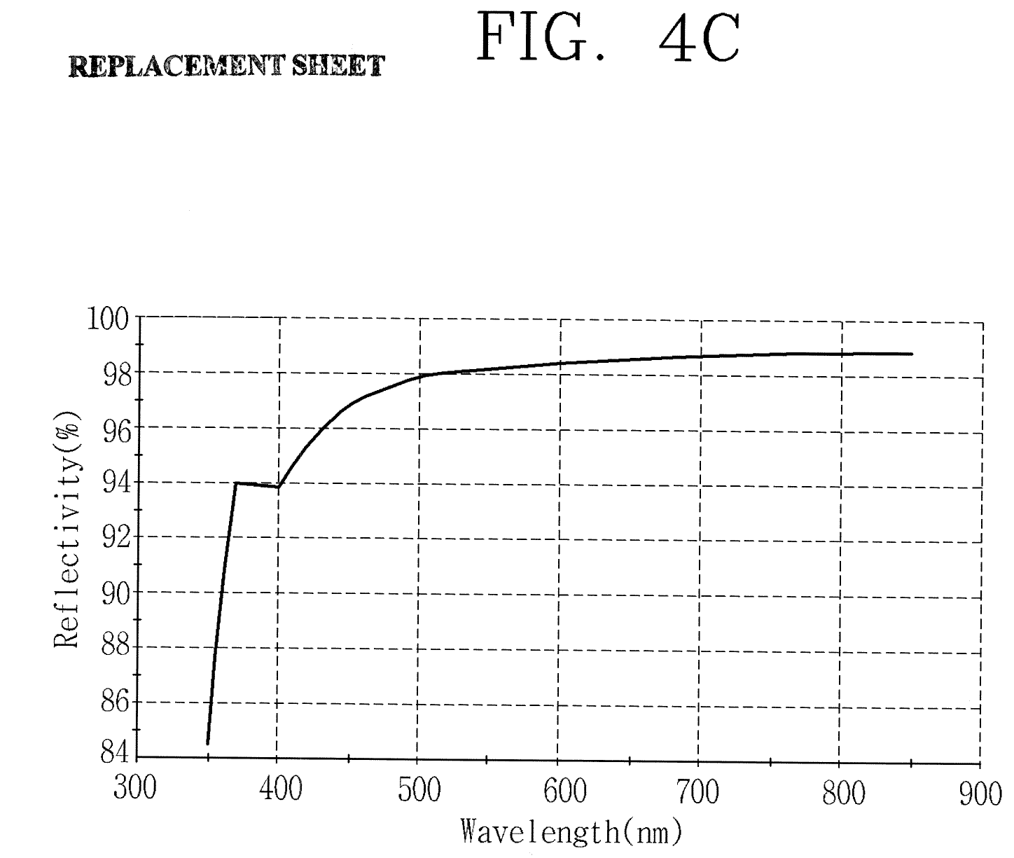

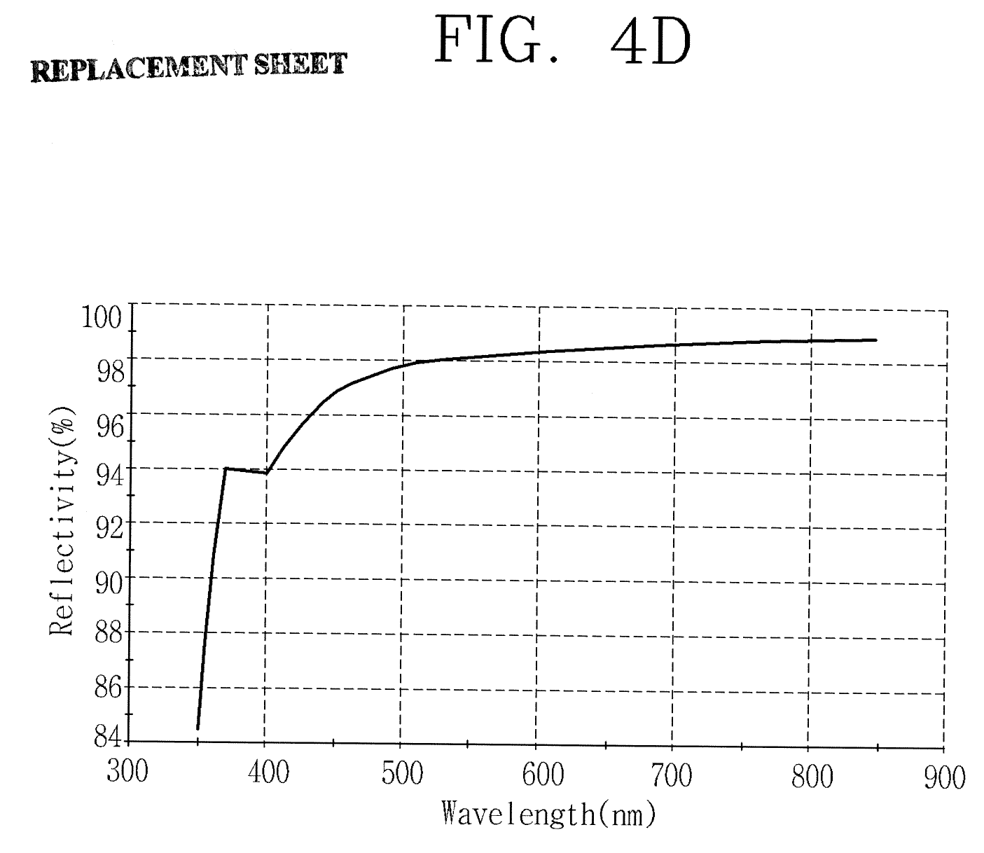

FIGS. 4A to 4C are graphs showing the variation in light reflectivity depending on the thickness of the reflecting layer of an integrated light guide plate. The reflecting layer used herein was made of Ag.

FIG. 4A shows that the reflectivity of light in the visible light and Infrared (IR) bands is 96% or more when the thickness of the reflecting layer of the integrated light guide plate is 70 nm. FIG. 4B shows that the reflectivity of light in the visible light and IR bands is 97% or more when the thickness of the reflecting layer of the integrated light guide plate is 200 nm. FIG. 4C shows that the reflectivity of light in the visible light and IR bands is 98% or more when the thickness of the reflecting layer of the integrated light guide plate is 1 μm. FIG. 4D shows that the reflectivity of light in the visible light and IR bands is 98% or more when the thickness of the reflecting layer of the integrated light guide plate is 200 μm.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An integrated light guide plate comprising:
a light guide plate, wherein the light guide plate forms planar light by guiding light; and
a reflecting mirror integrally formed on an underside of the light guide plate, the reflecting mirror comprising a buffer layer, a reflecting layer and a protective layer,
wherein the buffer layer is formed on the underside of light guide plate, and enhances bonding force between the reflecting layer and the light guide plate,
the reflecting layer is formed on an underside of the buffer layer, and reflects light that has downwardly passed through the light guide plate, to be introduced again into the light guide plate, and
the protective layer is formed on an underside of the reflecting layer, and protects the reflecting layer.

2. The integrated light guide plate of claim 1, wherein the buffer layer is made of titanium or a titanium alloy.

3. The integrated light guide plate of claim 1, wherein the reflecting layer is made of a metal.

4. The integrated light guide plate of claim 3, wherein the metal is one selected from the group consisting of silver, aluminum, copper, and gold.

5. The integrated light guide plate of claim 1, wherein the reflecting layer has a thickness ranging from 70 nm to 200 μm.

6. The integrated light guide plate of claim 1, wherein the protective layer is made of one selected from the group consisting of titanium dioxide, zinc oxide, tin dioxide, niobium oxide, and aluminum oxide.

7. The integrated light guide plate of claim 1, wherein the light guide plate has a dot pattern on the underside thereof, wherein the dot pattern scatters light.

8. The integrated light guide plate of claim 7, wherein a dot of the dot pattern increases in diameter as distance from a light source increases.

9. The integrated light guide plate of claim 1, wherein the light guide plate has protrusion-depression structures on the underside thereof, wherein the protrusion-depression structures scatter light.

10. The integrated light guide plate of claim 9, wherein the protrusion-depression structure increases in diameter as distance from a light source increases.

11. A backlight unit comprising the integrated light guide plate recited in claim 1.
